(19) United States
(12) Patent Application Publication
(10) Pub. No.: US 2015/0163486 A1
(43) Pub. Date: Jun. 11, 2015

(54) VARIABLE BITRATE ENCODING

(71) Applicant: Xinghai Li, North York (CA)

(72) Inventor: Xinghai Li, North York (CA)

(73) Assignee: VIXS SYSTEMS INC., Toronto (CA)

(21) Appl. No.: 14/100,385

(22) Filed: Dec. 9, 2013

(51) Int. Cl. H04N 19/93

(52) U.S. Cl. CPC H04N 19/00957

(57) ABSTRACT

A video processing device encodes an input video stream by dynamically varying an output bit rate for the resulting encoded video stream based on a length of the input video stream. A rate control module receives at least two parameters from an application requesting that the video stream be encoded: a target average bit rate (ABR) and a length of the video stream to be encoded. The rate control module varies the output bit rate according to the complexity of video information in the video stream and the remaining length of the video stream that has not been encoded. In addition, the rate control module constrains the output bit rate to ensure that the ABR is achieved for the entire encoded video stream.

### FIELD OF THE DISCLOSURE

The present disclosure generally relates to encoding of video signals and more particularly relates to variable bitrate encoding of video signals.

### BACKGROUND

In many electronic devices, video information is encoded to reduce the size of the information and thus reducing the resources required to communicate or store the video information. The encoded video information is typically decoded before it is displayed. To ensure reliable communication of video information between different electronic devices, standards have been promulgated for many encoding methods including the H.264 standard that is also referred to as MPEG-4, part 10 or Advanced Video Coding, (AVC). Rate control is frequently employed in video encoding or transcoding applications in an attempt to ensure that picture data being encoded meets various constraints, such as network bandwidth limitations, storage limitations, or processing bandwidth limitations, which may dynamically change. These constraints are reflected in the target bit rate for the resulting encoded video stream, and thus the goal of rate control is to maintain the bit rate of the encoded stream within a certain range of the target bit rate.

### BRIEF DESCRIPTION OF THE DRAWINGS

The present disclosure may be better understood, and its numerous features and advantages made apparent to those skilled in the art by referencing the accompanying drawings.

FIG. 1 is a block diagram illustrating a multimedia system in accordance with at least one embodiment of the present disclosure.

FIG. 2 is a block diagram illustrating an example configuration of a rate control module and an encoder of the multimedia system of FIG. 1 in accordance with at least one embodiment of the present disclosure.

FIG. 3 is a diagram illustrating an example of rate control based on complexity and length of a video stream in accordance with at least one embodiment of the present disclosure.

FIG. 4 is a diagram illustrating another example of rate control based on complexity and length of a video stream in accordance with at least one embodiment of the present disclosure.

FIG. 5 is a flow diagram illustrating a method of rate control for encoding a video stream based on complexity and length of a video stream in accordance with at least one embodiment of the present disclosure.

### DETAILED DESCRIPTION

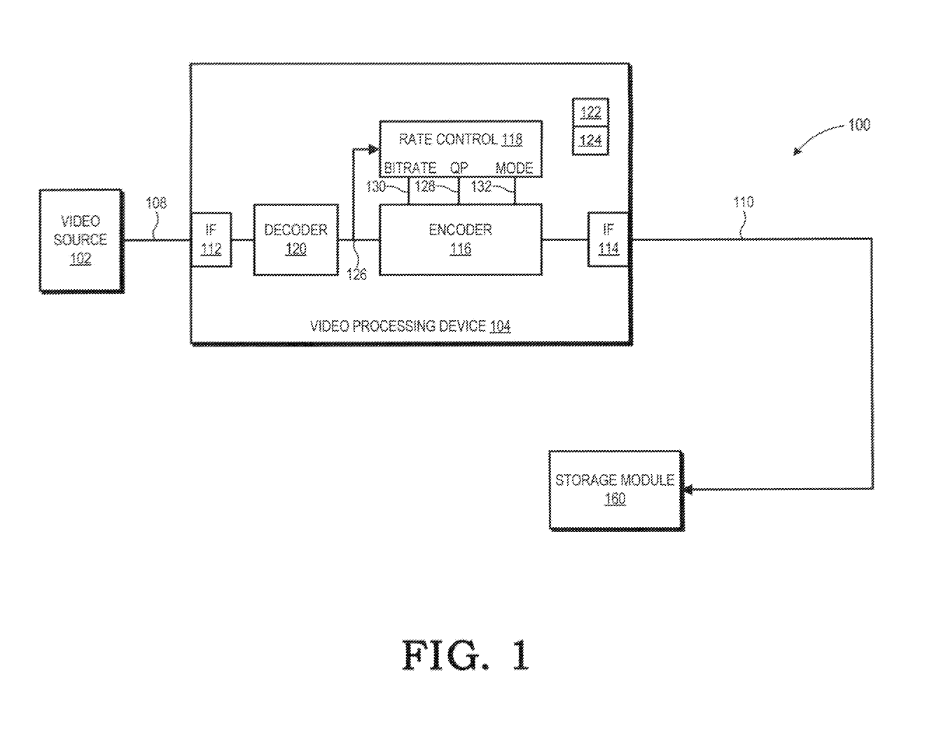

FIGS. 1-5 illustrate techniques for encoding an input video stream by dynamically varying an output bit rate for the resulting encoded video stream based on a length of the input video stream. A rate control module receives at least two parameters from an application requesting that the video stream be encoded: a target average bit rate (ABR) and a length of the video stream to be encoded. The rate control module varies the output bit rate according to the complexity of video information in the video stream and the remaining length of the video stream that has not been encoded. In addition, the rate control module constrains the output bit rate to ensure that the ABR is achieved for the entire encoded video stream. By taking into account the length of the remaining video stream to be encoded, the rate control module can sometimes encode complex video information in the stream at a higher bit rate, enhancing the quality and fidelity of the encoded video stream, relative to an encoding process where the length of the video stream is ignored.

To illustrate via an example, in some scenarios an encoder may identify, early in a video stream, a relatively complex portion of video information. In order to maintain quality of the encoded video stream, it is desirable for the encoder to increase the output bit rate. However, if the length of the video stream is ignored, the encoder typically must set the output bit rate to a relatively lower level than might otherwise be desirable in order to account for potential additional complex portions later in the video stream that are to be encoded. In particular, when the length of the video stream is unknown, the amount of potential additional complex portions is also unknown and difficult to predict. Further, failure to account for those additional complex portions can lead to an undesirably low output bit rate for the additional complex portions, resulting in poor quality of the encoded video stream, or to the ABR being exceeded for the encoded video stream, causing storage overflow or other errors. Accordingly, to avoid such errors by accounting for the possibility of the additional complex portions, the encoder can set the output bit rate, even for relatively complex portions, to a relatively low rate, potentially reducing the overall quality of the encoded video stream more than is needed to achieve the target ABR. By taking into account the length of the input video stream, the encoder can more aggressively set the output bit rate for complex portions of the video stream. For example, if the encoder identifies that there is a lot of time remaining in the video stream when a complex portion of the input video stream is encountered, it can set the output bit rate to a relatively high level, under the assumption that there will be relatively few complex portions remaining and the target ABR can therefore be achieved. If the encoder identifies that there is relatively little time remaining before the end of the video stream when a complex portion of the video stream is encountered, the encoder can set the output bit rate to a relatively low level to ensure that the ABR is achieved. The encoder can thus improve the overall quality of the encoded video stream while ensuring that the ABR is achieved.

For ease of illustration, the techniques of the present disclosure are described in the example context of the ITU-T H.264 encoding standards, which are also commonly referred to as the MPEG-4 Part 10 standards or the Advanced Video Coding (AVC) standards. However, the techniques of the present disclosure are not limited to this context, but instead may be implemented in any of a variety of block-based video compression techniques, examples of which include the MPEG-2 standards and the ITU-T H.263 standards.

FIG. 1 illustrates, in block diagram form, a multimedia system 100 in accordance with at least one embodiment of the present disclosure. The multimedia system 100 includes a video source 102, a video processing device 104, and a storage module 160. The multimedia system 100 can represent any of a variety of multimedia systems in which encoding or transcoding can be advantageously used. In one embodiment, the multimedia system 100 is a video recording system such as a digital video recorder (DVR), whereby the video source 102 comprises a terrestrial, cable, or satellite television broadcaster, an over-the-top (OTT) multimedia source or other Internet-based multimedia source, and the like. In this implementation, the video processing device 104 and the storage module 160 together are implemented as user equipment, such as a set-top box, a tablet computer or personal computer, a computing-enabled cellular phone, and the like. Thus, the video processing device 104 encodes or transcodes an input video stream and the resulting encoded video stream is buffered or otherwise stored at the storage module 160 for subsequent retrieval and playback. The storage module 160 can be a cache, memory, hard drive or other storage device that allows stored video to be accessed for decoding and display at a video destination (not shown) such as a television monitor.

In operation, the video source 102 transmits or otherwise provides an input video stream 108 to the video processing device 104 in either an analog format, such as a National Television System Committee (NTSC) or Phase Alternating Line (PAL) format, or a digital format, such as an H.263 format, an H.264 format, a Moving Picture Experts Group (MPEG) format (such as MPEG1, MPEG-2 or MPEG4), QuickTime format, Real Media format, Windows Media Video (WMV) or Audio Video Interleave (AVI), or other digital video format, either standard or proprietary. In instances whereby the input video stream 108 has an analog format, the video processing device 104 operates to encode the input video stream 108 to generate an encoded video stream 110, and in instances whereby the input video stream 108 has a digital format, the video processing device 104 operates to transcode the input video stream 108 to generate the encoded video stream 110. The resulting encoded video stream 110 is stored at the storage module 160 for subsequent decoding and display.

In the illustrated embodiment, the video processing device 104 includes interfaces 112 and 114, an encoder 116, a rate control module 118, and, in instances whereby the video processing device 104 provides transcoding, a decoder 120. The interfaces 112 and 114 include interfaces used to communicate signaling with the video source 102 and the video destination 106, respectively. Examples of the interfaces 112 and 114 include input/output (I/O) interfaces, such as Peripheral Component Interconnect Express (PCIE), Universal Serial Bus (USB), Serial Attached Technology Attachment (SATA), wired network interfaces such as Ethernet, or wireless network interfaces, such as IEEE 802.11x or Bluetooth™ or a wireless cellular interface, such as a 3GPP, 4G, or LTE cellular data standard. The decoder 120, the encoder 116, and rate control module 118 each may be implemented entirely in hard-coded logic (that is, hardware), as the combination of software stored in a memory 122 and a processor 124 to access and execute the software, or as combination of hard-coded logic and software-executed functionality. To illustrate, in one embodiment, the video processing device 104 is implemented as a SOC whereby portions of the decoder 120, the encoder 116, and the rate control module 118 are implemented as hardware logic, and other portions are implemented via firmware stored at the SOC and executed by a processor of the SOC.

The hardware of the video processing device 104 can be implemented using a single processing device or a plurality of processing devices. Such processing devices can include a central processing unit (CPU), a graphics processing unit (GPU), a microcontroller, a digital signal processor, a field programmable gate array, programmable logic device, state machine, logic circuitry, analog circuitry, digital circuitry, or any device that manipulates signals (analog and/or digital) based on operational instructions that are stored in a memory, such as the memory 122. The memory 122 may be a single memory device or a plurality of memory devices. Such memory devices can include a hard disk drive or other disk drive, read-only memory, random access memory, volatile memory, non-volatile memory, static memory, dynamic memory, flash memory, cache memory, and/or any device that stores digital information. Note that when the processing module implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry.

In a transcoding mode, the decoder 120 operates to receive the input video stream 108 via the interface 112 and partially or fully decode the input video stream 108 to create a decoded data stream 126, which can include pixel information, motion estimation/detection information, timing information, and other video parameters. The encoder 116 receives the decoded data stream 126 and uses the video parameters represented by the decoded data stream to generate the encoded video stream 110, which comprises a transcoded representation of the video content of the original input video stream 108. The transcoding process implemented by the encoder 116 can include, for example, a stream format change (e.g., conversion from an MPEG-2 format to an AVC format), a resolution change, a frame rate change, a bit rate change, and the like. In an encoding mode, the decoder 120 is bypassed and the input video stream 108 is digitized and then encoded by the encoder 116 to generate the encoded video stream 110.

In at least one embodiment, the video source 102 provides to the video processing device information indicating the length of the input video stream 108, such as by indicating, for example, an amount of time it takes to display video based on the input video stream 108 at a designated frame rate. For example, the input video stream 108 can represent a program or portion of a program to be recorded, and the length of the input video stream 108 can be indicated by the amount of time it would require to display the program or portion of the program, at a designated frame rate. The length of the input video stream 108 can be provided via a user input, via an electronic programming guide, and the like. For example, the video stream 108 may be generated in response to a user request to record a program represented by the input video stream 108. In response, the video processing device 104 can identify (e.g. based on an electronic programming guide) a length of the program when the program is displayed at a typical frame rate (e.g. 60 frames per second). Based on this information, the video processing device 104 can identify the length of the input video stream 108 using a linear transformation that relates the length of the program to the length of the input video stream 108.

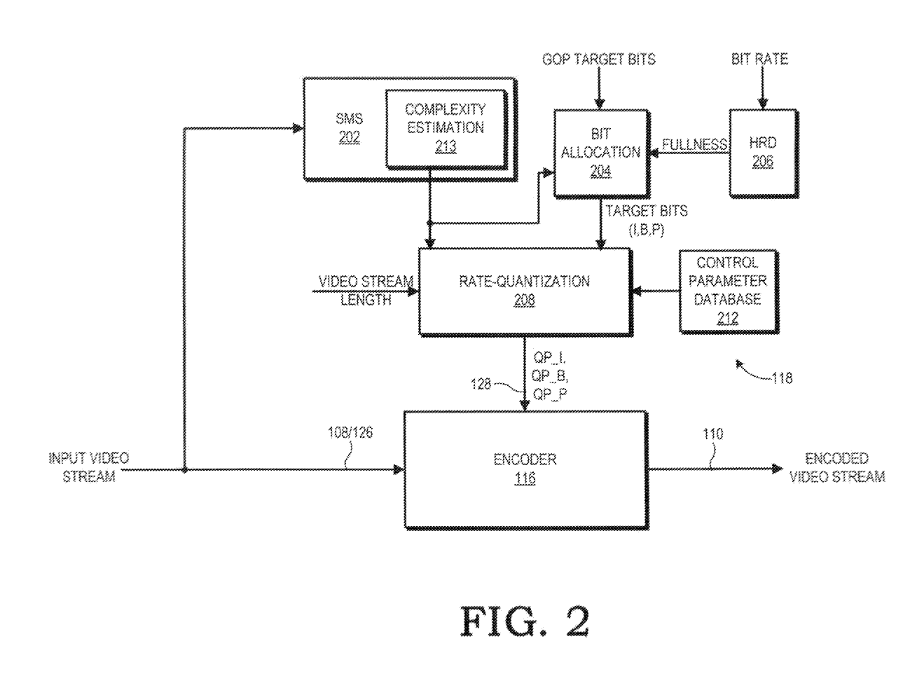

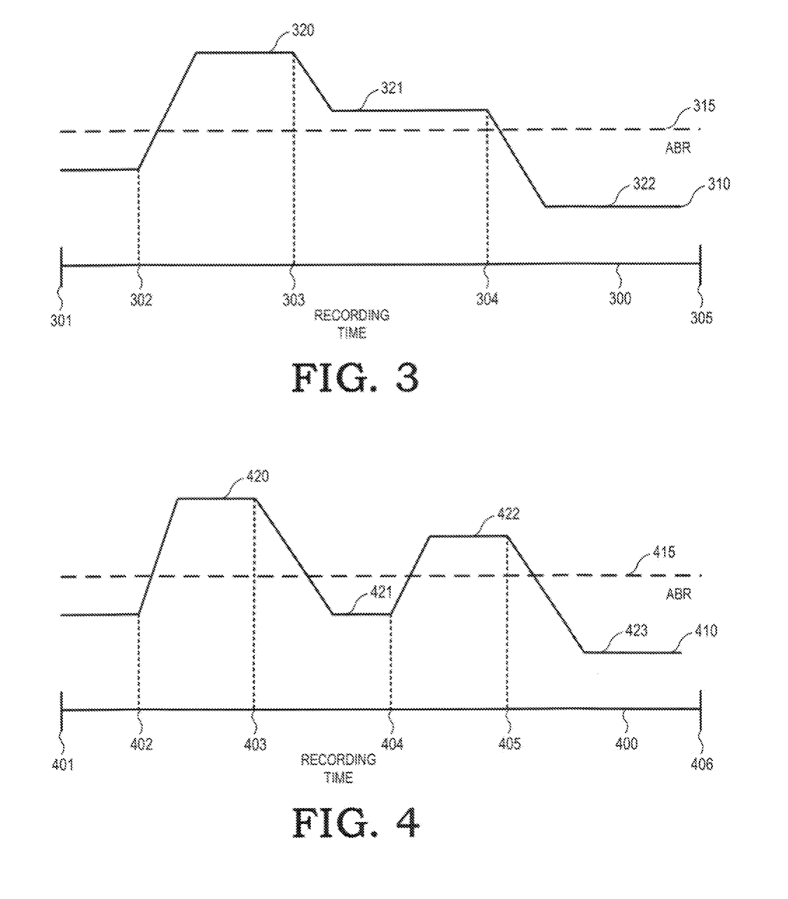

In at least one embodiment, the rate control module 118 utilizes the length of the input video stream 108 to determine the length of the portion of the stream that has not yet been encoded (referred for purposes of description as the “remaining stream time”) and to dynamically determine and adjust various encoding parameters used by the encoder 116 based on the remaining stream time. In one embodiment, these encoding parameters include a control signal 128 (denoted “QP” in FIG. 1) to configure one or more quantization parameters used during by quantization process of the encoder 116, a control signal 130 (denoted “BITRATE” in FIG. 2) to configure the target bit allocation for one or more picture types, as well as a control signal 132 (denoted “MODE” in FIG. 1) to select an encoding mode to be employed by the encoder 116. As described in greater detail below with reference to FIG. 3 and FIG. 4, the rate control module 118 continuously monitors the complexity of the pictures to be encoded and the remaining stream time to determine updated QP values and updated target bitrate allocations and signals the new QP values and target bitrate allocations via control signals 128 and 130, respectively.

FIG. 2 illustrates an example implementation of the rate control module 118 in greater detail in accordance with at least one embodiment of the present disclosure. In the depicted example, the rate control module 118 includes a SMS module 202, a bit allocation module 204, a hypothetical reference decoder (HRD) 206, and a rate-quantization module 208.

In operation, the encoder 116 employs a subtraction process and motion estimation process for data representing macroblocks of pixel values for a picture to be encoded. The motion estimation process, employed by the SMS module 202, compares each of these new macroblocks with macroblocks in a previously stored reference picture or pictures to find the macroblock in a reference picture that most closely matches the new macroblock. The motion estimation process then calculates a motion vector, which represents the horizontal and vertical displacement from the macroblock being encoded to the matching macroblock-sized area in the reference picture. The motion estimation process also provides this matching macroblock (known as a predicted macroblock) out of the reference picture memory to the subtraction process, whereby it is subtracted, on a pixel-by-pixel basis, from the new macroblock entering the encoder. This forms an error prediction, or “residual”, that represents the difference between the predicted macroblock and the actual macroblock being encoded. The encoder 116 employs a two-dimensional (2D) discrete cosine transform (DCT) to transform the residual from the spatial domain. The resulting DCT coefficients of the residual are then quantized using a corresponding QP so as to reduce the number of bits needed to represent each coefficient. The quantized DCT coefficients then may be Huffman run/level coded to further reduces the average number of bits per coefficient. This is combined with motion vector data and other side information (including an indication of I, P or B pictures) for insertion into the encoded video stream 110.

For the case of P/B reference pictures, the quantized DCT coefficients also go to an internal loop that represents the operation of the decoder (a decoder within the encoder). The residual is inverse quantized and inverse DCT transformed. The predicted macroblock is read out of the reference picture memory is added back to the residual on a pixel by pixel basis and stored back into a memory to serve as a reference for predicting subsequent pictures. The encoding of I pictures uses the same process, except that no motion estimation occurs and the negative (−) input to the subtraction process is to be spatial predicted. In this case the quantized DCT coefficients represent residual values from spatial prediction rather than from both temporal and spatial prediction as was the case for P and B pictures. As is the case for P/B reference pictures, decoded I pictures are stored as reference pictures.

The rate quantization module 208 receives the length of the input video stream 108 and, based on the length, continuously identifies the remaining stream time. The rate-quantization module 208 uses the image complexity, target bit allocations, and remaining stream time as parameters for determining the QP, which in turn determines the degree of quantization performed by the encoder 116 and thus influences the bit rate of the resulting encoded video data. In one embodiment, the image complexity is estimated by an complexity estimation module 213 (implemented, for example, as part of the SMS module 202), which calculates a SVAR metric and a PCOST metric from the residuals and other pixel information of a picture as an estimate of image complexity for a picture to be encoded. The SVAR and PCOST metrics may be calculated using any of a variety of well-known algorithms. The bit allocations are represented by target numbers of bits that may be allocated at different granularities, such as per picture, GOP, slice, or block. In one embodiment, the HRD 206 maintains a model of the buffer fullness (e.g., a coded picture buffer (CPB)) of a modeled decoder at the video destination 106 (FIG. 1) receiving the encoded video stream 110. The bit allocation module 204 determines the number of target bits to allocate based on the buffer fullness, the SVAR and PCOST metrics, the remaining stream time, the group of pictures (GOP) structure, and a specified target average bit rate, which can include a specific bit rate or a bit rate range, using any of a variety of well-known bit allocation algorithms. In at least one embodiment, the rate quantization module 208 applies a weight to an initial value of the QP based on the remaining stream time to identify a final QP used to encode a portion of the input video stream 108. For example, in some embodiments, the rate quantization module 208 identifies the remaining stream time and divides it by a defined constant to determine a corresponding weight. The rate quantization module 208 identifies an initial value of QP based on the SVAR and PCOST metrics, then multiplies the initial QP value by the weight to identify the final QP value. The bit allocation module 204 uses the final QP value to identify the number of target bits.

FIG. 3 illustrates an example of the rate control module 118 adjusting the bit rate of the encoded video stream 110 in accordance with at least one embodiment. FIG. 3 illustrates a timeline 300 and a corresponding curve 310. The curve 310 illustrates the bit rate of the encoded video stream 110. Curve 315 illustrates the ABR required by an application that requested encoding of the input video stream 108. Time 301 of the timeline 300 indicates the beginning of the input video stream 108 to be encoded, and time 305 indicates the end of the input video stream 108 to be encoded. Thus, the length of the input video stream is defined by the times 301 and 305. It is assumed that the input video stream 108 is being encoded in a streaming fashion, as it is received, rather than based on the entire input video stream 108 being stored and subsequently encoded.

At time 302, the rate control module 118 identifies a relatively complex portion of the input video stream 108 is to be encoded. Further, based on the length of the input video stream 108, the rate control module 118 identifies that the remaining stream time has a relatively large value. Accordingly, the rate control module 118 sets the bit rate for the encoded video stream 110 to a level designated level 320. At time 303, the rate control module 118 identifies that the input video stream still has the same complexity as identified at time 302 (e.g. has the same SVAR and PCOST metrics) but the remaining stream time (the time before time 305) is below a threshold. In response, the rate control module 118 lowers the bit rate for the encoded video stream 110 to a lower level, designated level 321. At time 304, the rate control module 118 identifies that the complexity of the input video stream 108 has fallen, and in response sets the bit rate for the encoded video stream 110 to a lower level, designated level 322, to ensure that the encoded video stream 110 meets the ABR 315.

FIG. 4 illustrates another example of the rate control module 118 adjusting the bit rate of the encoded video stream 110 in accordance with at least one embodiment. FIG. 4 illustrates a timeline 400 and a corresponding curve 410. The curve 410 illustrates the bit rate of the encoded video stream 110. Curve 415 illustrates the ABR required by an application that requested encoding of the input video stream 108. Time 401 of the timeline 400 indicates the beginning of the input video stream 108 to be encoded, and time 405 indicates the end of the input video stream 108 to be encoded. Thus, the length of the input video stream is defined by the times 401 and 405.

At time 402, the rate control module 118 identifies a relatively complex portion of the input video stream 108 is to be encoded. Further, based on the length of the input video stream 108, the rate control module 118 identifies that the remaining stream time has a relatively large value. Accordingly, the rate control module 118 sets the bit rate for the encoded video stream 110 to a level designated level 420. At time 403, the rate control module 118 identifies that the complexity of the input video stream 108 has fallen, and in response lowers the bit rate for the encoded video stream 110 to a lower level, designated level 421. At time 404, the rate control module 118 identifies that the input video stream 108 has returned to the same complexity as identified at time 402 (e.g. has the same SVAR and PCOST metrics). However, the rate control module 118 identifies that the remaining stream time is lower. Accordingly, the rate control module 118 increases the bit rate for the encoded video stream 110 to a level designated level 422. This level is higher than for less complex portions of the input video stream 108, but is lower than level 420 to account for the fact that there is less remaining stream time, and therefore subsequent complex portions of the input video stream 108 could cause the ABR 415 to be exceeded if the bit rate were set to level 420. At time 405, the rate control module 118 identifies that the complexity of the input video stream 108 has fallen, and in response sets the bit rate for the encoded video stream 110 to a lower level, designated level 423, to ensure that the encoded video stream 110 meets the ABR 315.

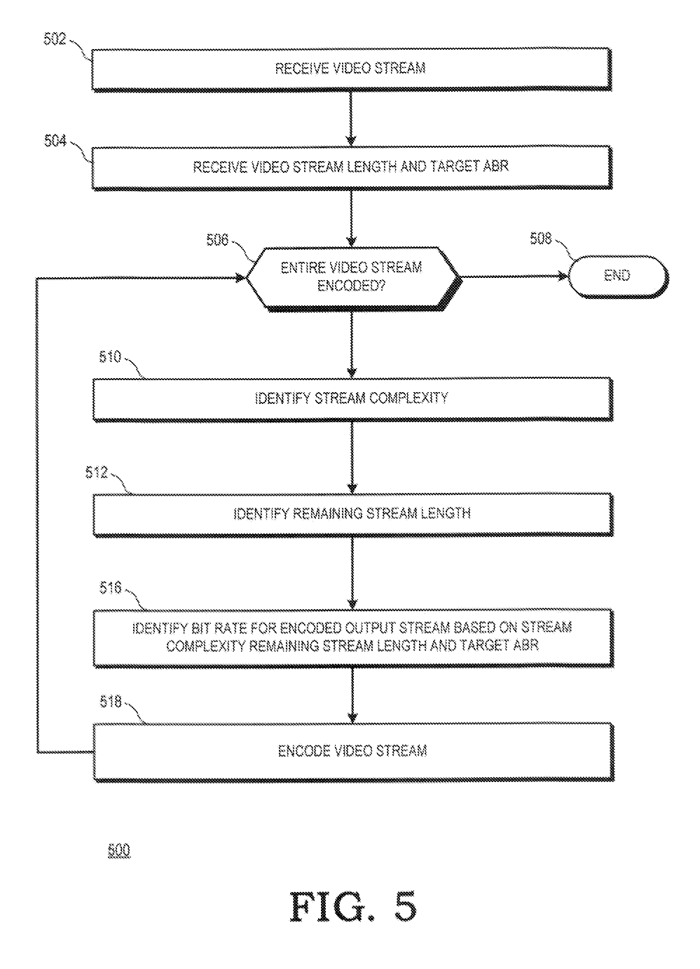

FIG. 5 illustrates a flow diagram of method 500 of setting a bit rate for an encoded video stream based on a length of an input video stream in accordance with at least one embodiment. For purposes of description, the method is described with respect to an example implementation at the video processing device 104 of FIG. 1. At block 502 the video processing device 104 receives the input video stream 108. At block 504 the video processing device 104 receives the target ABR for encoding the input video stream 108 and the length of the video stream 108. At block 506, the encoder 116 identifies whether the entire video stream 108 has been encoded as the encoded video stream 110. If so, the method flow moves to block 508 and the method ends.

If, at block 506, the encoder 116 identifies that there is additional information in the input video stream 108 to be encoded, the method flow moves to block 510 and the rate control module 118 identifies a complexity for the next portion of the input video stream 108 to be encoded. At block 512 the rate control module identifies, based on the time that the portion to be encoded occurs in the video stream 108 and the length of the video stream 108, the remaining stream length. At block 514 the rate control module sets the bit rate for encoding the portion of the input video stream 108 based on the target ABR, the remaining stream length, and the complexity of the portion. At block 516 the encoder 116 encodes the portion of the input video stream so that the corresponding portion of the encoded output stream 110 has the bit rate set at block 514. The method flow returns to block 506.

In this document, relational terms such as “first” and “second”, and the like, may be used solely to distinguish one entity or action from another entity or action without necessarily requiring or implying any actual relationship or order between such entities or actions or any actual relationship or order between such entities and claimed elements. The term “another”, as used herein, is defined as at least a second or more. The terms “including”, “having”, or any variation thereof, as used herein, are defined as comprising.

Other embodiments, uses, and advantages of the disclosure will be apparent to those skilled in the art from consideration of the specification and practice of the disclosure disclosed herein. The specification and drawings should be considered as examples only, and the scope of the disclosure is accordingly intended to be limited only by the following claims and equivalents thereof.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed.

Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

What is claimed is:

1. A method comprising:
identifying a length of a video stream; and
encoding the video stream at a variable bit rate based on the length of the video stream.

2. The method of claim 1, wherein identifying the length of the video stream comprises:
identifying the length of the video stream based on an amount of time corresponding to the length of the video stream.

3. The method of claim 2, further comprising:
storing the encoded video stream for subsequent playback;
wherein the amount of time corresponds to a playback time of the encoded video stream at a designated frame rate.

4. The method of claim 2, further comprising:
identifying the amount of time based on a user input requesting that the video stream be recorded.

5. The method of claim 2, further comprising:
identifying the amount of time based on program guide information.

6. The method of claim 1, wherein encoding the video stream comprises:
encoding the video stream at the variable bit rate based on the length of the video stream and a complexity of the video stream.

7. The method of claim 1, wherein encoding the video stream at the variable bit rate comprises:
at a first time, encoding the video stream at a first bit rate in response to identifying the video stream having a first complexity and in response to there being a first amount of the video stream remaining to be encoded; and
at a second time, encoding the video stream at a second bit rate in response to identifying the video stream having the first complexity and in response to there being a second amount of the video stream remaining to be encoded, the second amount different from the first amount.

8. The method of claim 7, further comprising:
at a third time, encoding the video stream at a third bit rate in response to identifying the video stream having a second complexity and in response to their being a third amount of time of the video stream remaining to be encoded.

9. A method, comprising:
identifying, at a first time, a first amount of a video stream remaining to be encoded; and
encoding a first portion of the video stream at a first bit rate based on the first amount.

10. The method of claim 9, further comprising:
identifying, at a second time, a second amount of the video stream remaining to be encoded; and
encoding a second portion of the video stream at a second bit rate based on the second amount, the second bit rate different from the first bit rate.

11. The method of claim 10, further comprising:
identifying a first complexity associated with the video stream at the first time; and
wherein encoding the first portion of the video stream comprises encoding the first portion at the first bit rate based on the first amount and on the first complexity.

12. The method of claim 11, further comprising:
identifying a second complexity associated with the video stream at the second time, the second complexity different from the first complexity; and
wherein encoding the second portion of the video stream comprises encoding the second portion at the second bit rate based on the second amount and on the second complexity.

13. The method of claim 11, further comprising:
identifying the first complexity as associated with the video stream at the second time; and
wherein encoding the second portion of the video stream comprises encoding the second portion at the second bit rate based on the second amount and on the first complexity.

14. A video processing device comprising:
an interface to receive an input video stream having a length; and
an encoder to encode the input video stream to generate an encoded video stream at a variable bit rate based on the length of the input video stream.

15. The video processing device of claim 14, wherein the video processing device identifies the length of the video stream based on an amount of time corresponding to the length of the input video stream.

16. The video processing device of claim 15 wherein the video processing device is to:
store the encoded video stream for subsequent playback;
wherein the amount of time corresponds to a playback time of the encoded video stream at a designated frame rate.

17. The video processing device of claim 16, wherein the video processing device identifies the amount of time based on program guide information.

18. The video processing device of claim 14, wherein the encoder is to encode the input video stream at the variable bit rate based on the length of the video stream and a complexity of the video stream.

19. The video processing device of claim 14, wherein the encoder is to:
at a first time, encode the input video stream at a first bit rate in response to identifying the video stream having a first complexity and in response to there being a first amount of the video stream remaining to be encoded; and
at a second time, encode the input video stream at a second bit rate in response to identifying the video stream having the first complexity and in response to there being a second amount of the video stream remaining to be encoded, the second amount different from the first amount.

20. The video processing device of claim 19, wherein the encoder is to:
at a third time, encode the input video stream at a third bit rate in response to identifying the video stream having a second complexity and in response to their being a third amount of time of the video stream remaining to be encoded.
